(19) United States
(12) Patent Application Publication
(10) Pub. No.: US 2014/0284099 A1
(43) Pub. Date: Sep. 25, 2014

(54) WATER STOPPING STRUCTURE OF CORE WIRES AND WATER STOPPING METHOD OF CORE WIRES

(71) Applicant: Yazaki Corporation, Tokyo (JP)

(72) Inventor: Takahiro Saito, Kosai-shi (JP)

(73) Assignee: YAZAKI CORPORATION, Tokyo (JP)

(21) Appl. No.: 14/353,316

(22) PCT Filed: Nov. 16, 2012
(86) PCT No.: PCT/JP2012/080409

§ 371 Date: Apr. 22, 2014

(30) Foreign Application Priority Data
Nov. 17, 2011 (JP) 2011-251726

(51) Int. Cl. H01R 43/00; H01B 7/282; H01B 7/00

(52) U.S. Cl. CPC H01R 43/005; H01B 7/0009; H01B 7/282
USPC 174/70 R; 156/48

(57) ABSTRACT

A water stopping structure includes a covered electric having a plurality of core wires covered with an insulation cover, and a core wire welding portion provided in a part of the covered electric wire where the insulation cover is removed and the core wires are exposed to the outside. In the core wire welding portion, the core wires are welded to each other. A gap between the core wires, which has a size capable of being filled up with a low viscosity water stop material by capillarity action, is formed in the core wire welding portion. The gap is filled up with the water stop material.

### TECHNICAL FIELD

The present disclosure relates to a water stopping structure of core wires and a water stopping method of the core wires that prevent water permeation into the core wires of a covered electric wire.

### BACKGROUND ART

In a case where a ground terminal crimped to an electric wire, for example, is connected to a vehicle body which is present in a water exposed area, water permeates the inside of the electric wire from an exposed core wire portion which is crimped in the ground terminal and then the water often permeates devices or equipment which are connected to the opposite end of the electric wire. In order to prevent the permeation of water through such a route, there are cases where a water proofing treatment is performed with respect to a terminal swage portion or the water proofing treatment is performed with respect to a core wire portion positioned at a middle part of the electric wire (for example, refer to PTL 1).

As illustrated in FIG. 5A, in a ground electric wire 501 disclosed in PTL 1, core wires 507 which are exposed from the terminal of an electric wire (covered electric wire) 505 is swaged and crimped by a core wire crimping barrel 509 with respect to a ground terminal 503, and an insulation cover 511 is crimped by an insulation cover crimping barrel 513. Each of the core wires 507 is formed from a twisted wire which is not a single core wire, but configured by twisting multiple element wires together.

As illustrated in FIG. 5B, the electric wire 505, whose end portion is crimped and connected to a ground terminal 503, has an insulation cover 511 removed at a position close to a ground terminal connecting portion, thereby the core wire 507 is exposed.

Next, as illustrated in FIG. 5C, a welding portion 515 is formed by welding the exposed core wire 507 and integrating each of the twisted element wires together.

Then, as illustrated in FIG. 5D, a wide tape 519, made of insulation resin and on which silicon 517 is applied, is wound around the welding portion 515 and the core wire 507 exposed by removing the insulation cover 511.

As illustrated in FIG. 6, in the tape 519, an adhesive layer 521 is provided on the inner surface to which the silicon 517 is applied, and is firmly fixed by being wound around the core wire 507 and the welding portion 515.

The tape 519 is wound around by being extended up to the outer peripheral surface positioned at both sides of the insulation cover 511 of a peeled portion where the core wire 507 is exposed, and it is configured such that water permeation does not occur from a boundary between the exposed core wire 507 and the insulation cover 511. As illustrated in FIG. 6, according to such a procedure, the welding portion 515 and a portion between element wires of the front and the rear core wires 507 are filled up with the silicon 517, and are completely covered by the tape 519.

### CITATION LIST

### Patent Literature

[PTL 1] JP-A-2004-72943

### SUMMARY OF INVENTION

### Technical Problem

However, in the above water stopping structure of a ground electric wire 501 in the related art, stable waterproofing properties have been obtained in the case of a thin cable 523 which has a relatively small core wire diameter, illustrated in FIG. 7A. However, fluctuations in the waterproofing properties have occurred in a case of a thick cable 525 which has a large core wire diameter, illustrated in FIG. 7B. More specifically, the stable properties cannot be obtained except in a case of the thin cable 523 whose cross sectional area is up to 1.25 sq.

It is conceivable that the reason of lack of the stable waterproofing properties is because a gap occurring at a welding portion 515 in a case of the thick cable 525 is not considered in the water stopping structure of the ground electric wire 501 in the related art. That is, as illustrated in FIG. 7A, the welding portion 515 of the thin cable 523 brings the core wires into substantially close contact with each other, or is a closed space even if a minute gap 529 is formed. On the other hand, as illustrated in FIG. 7B, in some cases, the welding portion 515 of the thick cable 525 comes to have large gaps 531 and the gaps are communicated with each other. Since such large gaps 531 are formed in the thick cable 525 during actual work, it is important to eliminate the gaps 531.

In the above water stopping structure of the ground electric wire 501 in the related art, the tape 519 to which the silicon 517 is applied is wound around the welding portion 515. However, it is extremely difficult to fill up the large gaps 531 formed in the center vicinity of the welding portion 515 and communicate with the outside 527, with the silicon 517 applied to the tape 519. In addition, it is extremely difficult to heat the welding portion 515 until the large gaps 531 are completely eliminated, and thereby there is also a possibility that the welding portion 515 is melted and then flows out depending on fluctuations in heat capacity of the welding portion 515.

The present disclosure is made in consideration of the above-described circumstance and an object thereof is to provide a water stopping structure of core wires and a water stopping method of the core wires which enable stable waterproofing properties regardless of the thickness of a covered electric wire.

### Solution to Problem

The above-described object according to the present disclosure is achieved by the following configurations.
(1) There is provided a water stopping structure comprising:

a covered electric wire configured to have a plurality of core wires and an insulation cover covering the core wires; and

a core wire welding portion configured to be provided in a part of the covered electric wire where the insulation cover is removed and the core wires are exposed to the outside,

wherein in the core wire welding portion, the core wires are welded to each other;

wherein a gap between the core wires, which has a size capable of being filled up with a low viscosity water stop material by capillarity action, is formed in the core wire welding portion; and

wherein the gap is filled up with the water stop material.

According to the water stopping structure with the above-described configuration (1), in the core wire welding portion which is formed at the core wires of the covered electric wire by the welding process, there remains the gap with the size capable of being filled up with the low viscosity water stop material by the capillarity action. The size of the gap can be determined depending on the viscosity of the water stop material, wettability of the core wires or the like. Then, the gap of the core wire welding portion, where the capillarity action is easily induced, is filled up with the water stop material. Accordingly, water going through one side core wires across the core wire welding portion can no longer permeate the other side since the permeating route is reliably blocked and waterproofed in the core wire welding portion.

That is, the water transmitting between each of the core wires is stopped in the core wire welding portion. In addition, the water transmitting between the insulation cover and the outer periphery of a core wire bundle is stopped by the water stop material which covers the insulation cover and the core wire welding portion.
(2) The water stopping structure with above-described configuration (1), further comprises:

a heat shrinkable tube configured to cover the core wire welding portion and configured to be extended to the insulation cover adjacent at both ends of the core wire welding portion,

wherein the heat shrinkable tube is brought into close contact with the core wire welding portion and an outer peripheral surface of the insulation cover adjacent at both ends of the core wire welding portion.

According to the water stopping structure with the above-described configuration (2), the heat shrinkable tube is extended up to and brought into close contact with the outer peripheral surface of the insulation cover positioned at both ends of the core wire welding portion. Therefore, the water is also stopped between the core wire welding portion and the heat shrinkable tube. In addition, if the heat shrinkable tube is shrunk while the water stop material is in an uncured state, the uncured water stop material can be press-fitted into the gap of the core wire welding portion due to shrinking pressure of the heat shrinkable tube.
(3) There is provided a water stopping method comprising:

forming a core wire exposed portion by removing an insulation cover of a covered electric wire in which a plurality of core wires is covered with the insulation cover;

forming a core wire welding portion having a gap between the core wires, by shrinking to a size of the gap capable of being filled up with a low viscosity water stop material by capillarity action by performing a welding processing for the core wires of the core wire exposed portion; and

filling up the gap with the low viscosity water stop material by the capillarity action.

According to the water stopping method with the above-described process (3), the core wire exposed portion is formed by removing the middle of the insulation cover of the covered electric wire. The core wire welding portion is formed at the core wire exposed portion by performing the welding processing, for example, such as ultrasonic welding or resistance welding.

Then, the gap with the size capable of being filled up with the low viscosity water stop material by the capillarity action remains at the core wire welding portion. The size of the gap can be controlled, for example, using ultrasonic vibration of an ultrasonic welding machine or an electric current generated by a resistance welding machine. In this manner, the core wire welding portion having the gap where the capillarity is easily induced is dipped into the water stop material, for example, and thereby the gap which communicates with the outside is filled up with the water stop material. Accordingly, the water transmitting through one side of the core wires across the core wire welding portion can no longer permeate the other side since the permeating route is reliably blocked and waterproofed in the core wire welding portion.

That is, the water transmitting between the core wires is stopped in the core wire welding portion. In addition, the water transmitting between the insulation cover and the outer periphery of a core wire bundle is stopped by the water stop material which covers the insulation cover and the core wire welding portion.
(4) For example, the water stopping method, further comprises:

covering the core wire welding portion and the insulation cover adjacent at both ends of the core wire welding portion with a heat shrinkable tube; and

applying heat to the heat shrinkable tube so that the heat shrinkable is brought into close contact with the core wire welding portion and an outer peripheral surface of the insulation cover adjacent at both ends of the core wire welding portion.
(5) For example, the heat shrinkable tube is shrunk when the water stop material is in an uncured state so that the uncured water stop material is press-fitted into the gap due to shrinking pressure of the heat shrinkable tube.

### Advantageous Effects of Invention

According to the water stopping structure and the water stopping method of the present disclosure, it is possible to provide a water stopping structure of core wires and a water stopping method of the core wires which enable stable waterproofing properties regardless of thickness of cables.

The present disclosure is described with concision. In addition, the details of the present disclosure will be further clarified with reference to the accompanying drawings by reading aspects (hereinafter referred to as an “embodiment”) for implementing the present disclosure which is to be described below.

### BRIEF DESCRIPTION OF DRAWINGS

FIG. 1 is a plan view where a portion is cut away from a covered electric wire having a water stopping structure of core wires according to an embodiment of the present disclosure.

FIGS. 2A to 2F are process drawings illustrating a procedure of a water stopping process for core wires of the covered electric wire illustrated in FIG. 1.

FIG. 3A is an enlarged view of a main portion along the B-B cross-section in FIG. 2F, and FIG. 3B is a cross-sectional view along the C-C cross-section in FIG. 2F.

FIG. 4 is a cross-sectional view along the D-D cross-section in FIG. 2F.

FIGS. 5A to 5D are process drawings illustrating procedures of a water stopping process for core wires of a covered electric wire in the related art.

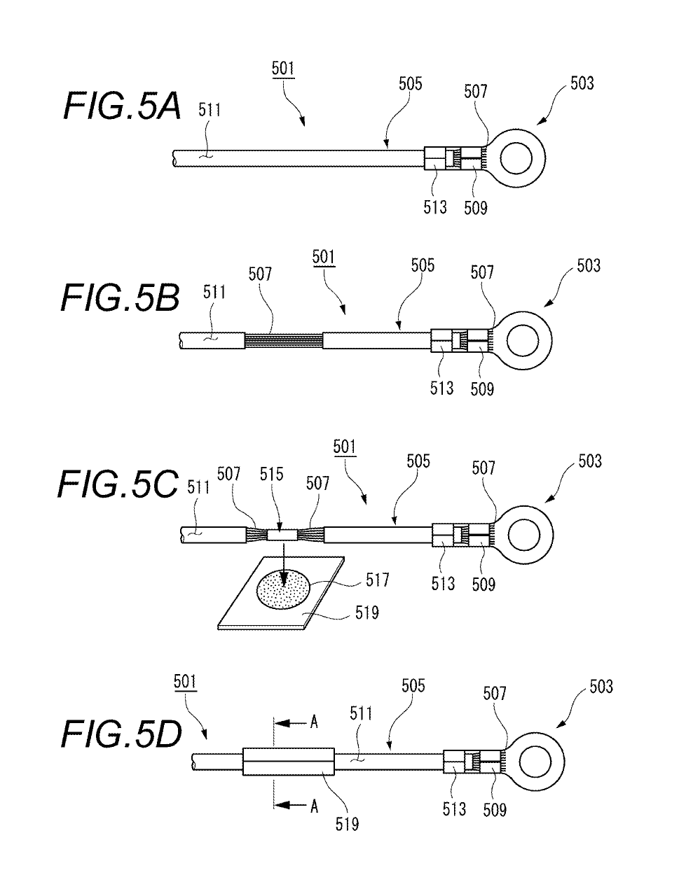

FIG. 6 is a cross-sectional view along the A-A cross-section in FIG. 5D.

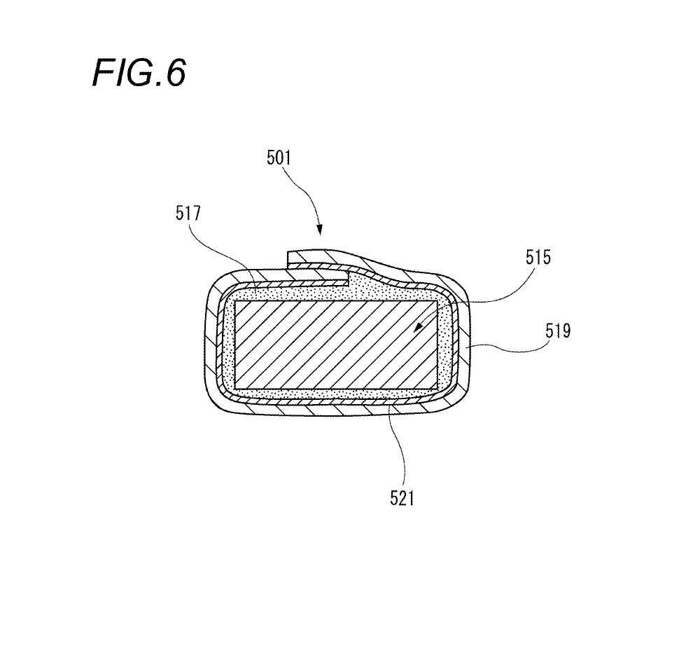

FIG. 7A is an enlarged cross-sectional view of a core wire welding portion of a thin cable according to a water stopping structure of the core wires in the related art, and FIG. 7B is an enlarged cross-sectional view of a core wire welding portion of a thick cable according to a water stopping structure of the core wires in the related art.

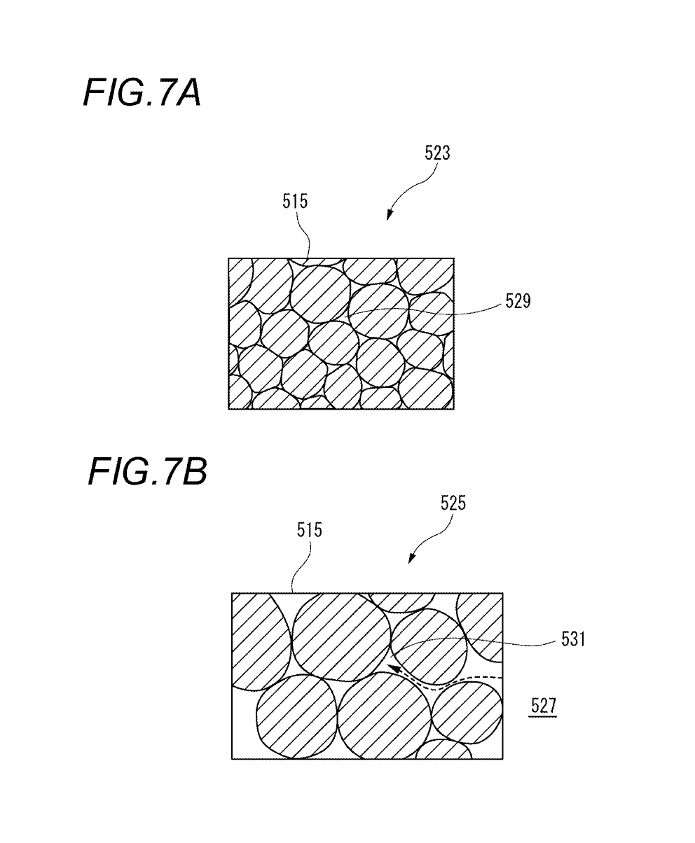

### DESCRIPTION OF EMBODIMENTS

Hereinafter, an embodiment according to the present disclosure will be described with reference to the accompanying drawings.

A covered electric wire 15 having a water stopping structure of core wires according to the present embodiment is applied to a ground electric wire (covered electric wire) 11, for example. The ground electric wire 11 can be preferably used in a case of blocking water which permeates the inside of the electric wire from an exposed core wire portion in a water exposed area and attempts to permeate a device or equipment connected to the opposite end of the ground electric wire 11. Furthermore, water is exemplified for water stopping in this description, but the present disclosure is effective for liquids in general, including oil, alcohol or the like in addition to the water.

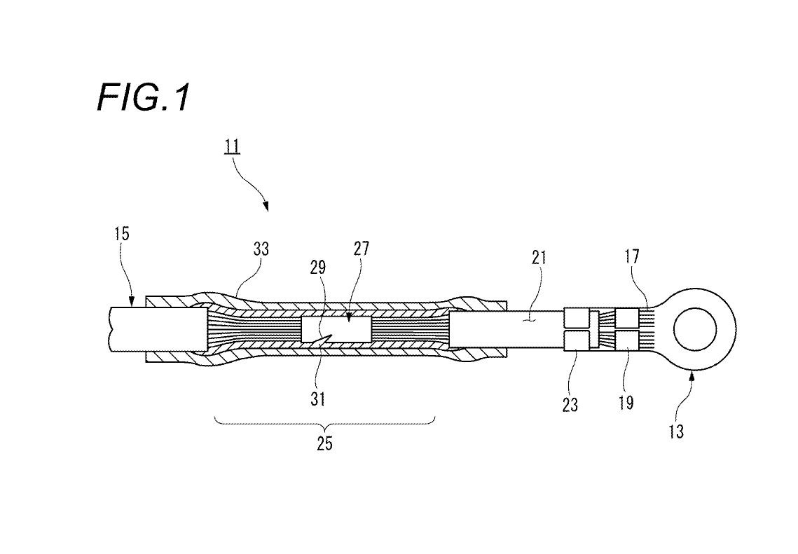

As illustrated in FIG. 1, for example, an LA terminal 13 is connected to an end portion of the ground electric wire 11. In the ground electric wire 11, core wires 17 exposed from an end portion of the covered electric wire 15 is crimped with a core wire crimping barrel 19 of the LA terminal 13, and an insulation cover 21 is crimped with an insulation cover crimping barrel 23. Each of the core wires 17 is not formed by a single core wire, but is formed from twisted wires configured by twisting a plurality of core wires 17. The core wires 17 are conductive wires made of copper, a copper alloy, aluminum, an aluminum alloy or the like.

In the ground electric wire 11 whose end portion is crimped and connected to the LA terminal 13, the insulation cover 21 is removed at a position close to the LA terminal 13, and a core wire exposed portion 25 is formed where the core wire 17 is exposed. A core wire welding portion 27 where the core wires 17 are bonded to each other by performing a welding processing for the core wires 17 is formed at the core wire exposed portion 25. That is, the bundled core wires 17 are welded to form a bonding portion where the core wires 17 are welded to each other.

As a method of welding each of the core wires 17, for example, an ultrasonic welding method, a resistance welding method or the like may be exemplified. Among them, it is preferable to adopt the ultrasonic welding method in view of a simple work and a reliable bonding. In order to perform the ultrasonic welding, the resistance welding or the like, a general ultrasonic welding machine or resistance welding machine can be used.

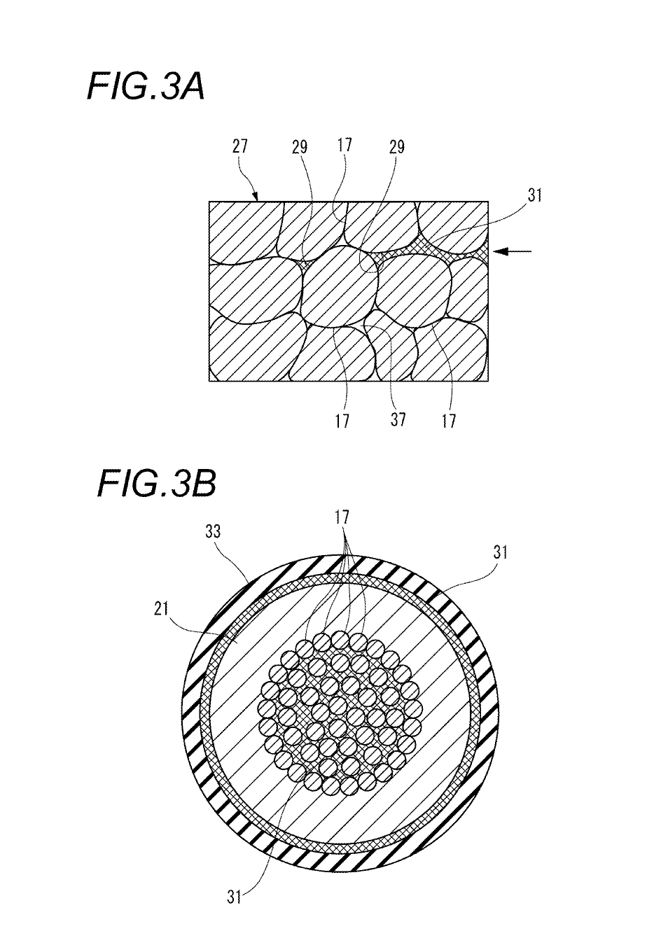

Herein, each of gaps 29 which is shrunk to a size capable of being filled up with a low viscosity water stop material 31 by capillarity action remains in the core wire welding portion 27 where each of the core wires 17 is welded together. In particular, in a case where the covered electric wire 15 is a thick cable, the gaps 29 easily remain in the core wire welding portion 27 (refer to FIG. 3A). The gaps 29 are filled up with the water stop material 31 by being dipped as will be described later.

As the water stop material 31, a low viscosity cyanoacrylate adhesive or the like may be exemplified. The low viscosity cyanoacrylate adhesive can easily permeate the gaps 29 by being simply dropped on the core wire welding portion 27 using a commercially available liquid dispensing instrument.

In addition, a core wire exposed portion 25 where the core wire welding portion 27 is formed, and the insulation cover 21 positioned at both sides of the core wire exposed portion 25 are also covered by the water stop material 31.

A heat shrinkable tube 33 is provided on the core wire exposed portion 25 covered by the water stop material 31, and then is heated to a desired temperature (approximately 200° C.), shrunk and brought into close contact therewith. The heat shrinkable tube 33 is extended up to and brought into close contact with the outer peripheral surface of the insulation cover 21 positioned at both sides of the core wire welding portion 27. As the heat shrinkable tube 33, for example, a product made by Raychem Corp. (waterproofing heat shrinkable tube: product name: ES-1) can be exemplified. Furthermore, the heat shrinkable tube 33 may be a hot melt type.

Next, an operation of the above-described water stopping structure of core wires will be described.

In the water stopping structure of core wires of the ground electric wire 11 according to the present embodiment, the core wires 17 are processed by welding, in the core wire exposed portion 25 where the insulation cover 21 of the covered electric wire 15 is removed, and the core wire welding portion 27 is formed. In a case of a thick cable, the gaps 29 generally remain in the core wire welding portion 27. However, each of the gaps 29 is shrunk to a size by a welding processing. The size of each of the shrunk gaps 29 is capable of being filled up with the low viscosity water stop material 31 by the capillarity action. In brief, it is in a state where each of the gaps 29 with the size capable of being filled up with the water stop material 31 is intentionally provided.

The size of each of the gaps 29 can be determined depending on viscosity of the water stop material 31, wettability of the core wire 17 or the like. The core wire welding portion 27 having the gaps 29 with size where the capillarity action is easily induced is dipped into the water stop material 31, and thereby the gaps 29 are filled up with the water stop material 31. Accordingly, water transmitting through one side core wires 17 across the core wire welding portion 27 can no longer permeate the other side since the permeating route is blocked and waterproofed in the core wire welding portion 27.

That is, if the water permeates the inside portion of the covered electric wire 15 from the exposed core wire which is crimped with the LA terminal 13, the water transmitting in spaces between the core wires 17 is stopped at the core wire welding portion 27. In addition, the water transmitting between the insulation cover 21 and the outer periphery of a core wire bundle is stopped by the water stop material 31 which covers the insulation cover 21 and the core wire welding portion 27. In addition, the heat shrinkable tube 33 is extended up to and brought into close contact with the outer peripheral surface of the insulation cover 21 positioned at both sides of the core wire welding portion 27. Therefore, the water is also stopped between the outer peripheral surface of the cured water stop material 31 and the heat shrinkable tube 33. In addition, if the heat shrinkable tube 33 is shrunk when the water stop material 31 is in an uncured state, the uncured water stop material 31 can be press-fitted into the gaps 29 due to shrinking pressure of the heat shrinkable tube 33.

Next, a procedure of a water stopping method of core wires according to an embodiment of the present disclosure will be described.

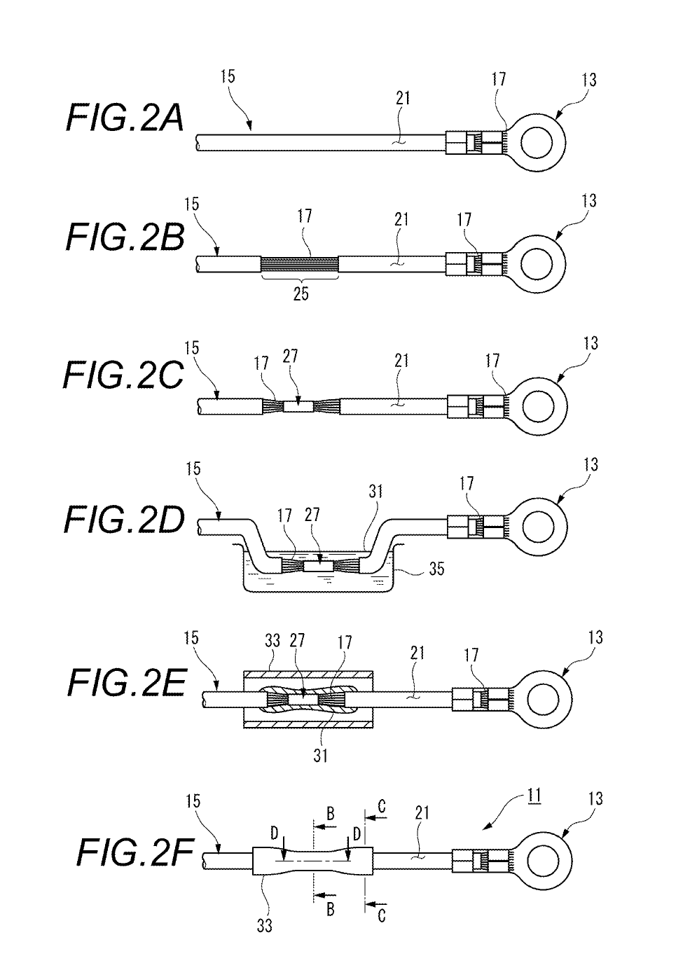

In the water stopping method of the core wires of the present embodiment, first, the insulation cover 21 of the covered electric wire 15 where the core wires 17 are covered with the insulation cover 21 illustrated in FIG. 2A is removed, and then the core wire exposed portion 25 illustrated in FIG. 2B is formed.

As illustrated in FIG. 2C, welding processing is performed for the core wires 17 of the core wire exposed portion 25 using ultrasonic welding, and the core wire welding portion 27 having the gaps 29 between the core wires 17 is formed.

Then, in the ultrasonic welding, the core wire exposed portion 25 is placed on an anvil of an ultrasonic welding machine (not illustrated), and a horn (vibrator) of the ultrasonic welding machine is disposed at a position coupling with the anvil by pinching the bundled core wires 17. Continuously, in a state where the bundled core wires 17 are pinched by the anvil and the horn, the horn is subjected to ultrasonic vibration. As the horn is in the ultrasonic vibration, the core wires 17 are heated due to friction and the core wires 17 are bonded to each other.

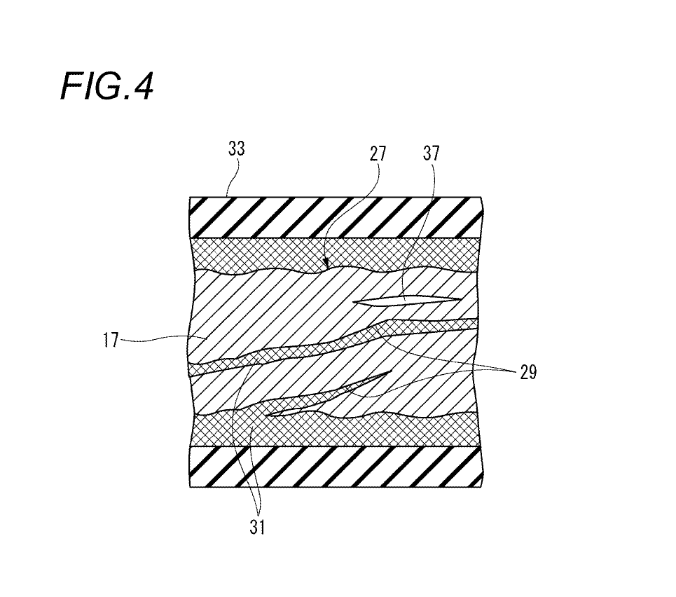

As illustrated in FIGS. 3A and 4, the gaps 29 remain in the core wire welding portion 27. However, the gaps 29 are shrunk to the size capable of being filled up with the low viscosity water stop material 31 by the capillarity action by welding processing for the gaps between the core wires 17. The gaps 29 penetrates through the inside of the core wire welding portion 27 in the axial direction thereof, or is extended from the outer peripheral portion of the core wire welding portion 27 to the inside thereof. The size of the gaps 29 is controlled by the ultrasonic vibration of the ultrasonic welding machine.

Next, as illustrated in FIG. 2D, the core wire welding portion 27 having the gaps 29 where the capillarity action is easily induced is dipped into a dip bath 35 which is full of the low viscosity water stop material 31, and then the gaps 29 are filled up with the water stop material 31.

As illustrated in FIG. 3A, in the core wire welding portion 27 which is dipped into the low viscosity water stop material 31, the water stop material 31 permeates the gaps 29 which communicate with the outside. In the covered electric wire 15 taken out from the dip bath 35, a water permeation route is blocked in the core wire welding portion 27 in such a manner that the water stop material 31 fills up the gaps 29.

Furthermore, as illustrated in FIG. 4, a minute gap 37 to be sealed is present in the core wire welding portion 27 in addition to the gaps 29. However, the minute gap 37 does not influence the waterproofing function since the minute gap 37 is not communicated with the outside or the other gaps 29. In other words, the water stop material 31 permeates only the gaps 29 which has influence on the waterproofing function.

In addition, the water stop material 31 which fills up the gaps 29 covers the core wire welding portion 27, the core wires 17 of the core wire exposed portion 25, and the insulation cover 21 positioned at both sides of the core wire exposed portion 25 as well. Accordingly, as illustrated in FIG. 3B, the water stop material 31 which covers the core wire exposed portion 25 also fills up portions among the core wires 17.

Next, as illustrated in FIG. 2E, the heat shrinkable tube 33 is laid over both of the core wire welding portion 27 and the insulation cover 21 positioned at both sides of the core wire welding portion 27. The heat shrinkable tube 33 is heated at a desired temperature and is shrunk. As illustrated in FIG. 2F, the heat shrinkable tube 33 is extended up to and brought into contact with the outer peripheral surface of the insulation cover 21 positioned at both sides of the core wire welding portion 27. Accordingly, as illustrated in FIG. 4, the water stop material 31 which covers the outer periphery of the insulation cover 21 is covered by the heat shrinkable tube 33.

Therefore, according to the water stopping structure of the core wires and the water stopping method of the core wires of the present embodiment, water transmitting through one side core wires 17 across the core wire welding portion 27 can no longer permeate the other side since the permeating route is reliably blocked and waterproofed in the core wire welding portion 27. That is, the water transmitting in spaces between the core wires 17 is reliably stopped in the core wire welding portion 27. In addition, the water transmitting between the insulation cover 21 and the outer periphery of a core wire bundle is stopped by the water stop material 31 which covers the insulation cover 21 and the core wire welding portion 27. Therefore, stable waterproofing properties can be obtained regardless of thickness of the covered electric wire 15.

Furthermore, the water stopping structure of the core wires and the water stopping method of the core wires of the present disclosure are not limited to the above-described embodiment, but may be appropriately changed or improved. In addition, a material quality, shape, dimension, number, disposed location or the like of each constituent element according to the above-described embodiment may be arbitrarily selected without any limitation as long as the present disclosure can be achieved.

For example, in the above-described embodiment, a case where the covered electric wire 15 is a thick cable is exemplified for the description. However, even in a case where the covered electric wire 15 is a thin cable, good waterproofing properties can be secured similarly.

The present application is based on Japanese Patent Application No. 2011-251726 filed on Nov. 17, 2011, the contents of which are incorporated herein by reference.

### INDUSTRIAL APPLICABILITY

A water stopping structure of core wires of a covered electric wire and a water stopping method of the core wires which enable stable waterproofing properties regardless of the thickness of the covered electric wire can be obtained.

### REFERENCE SIGNS LIST

11 ground electric wire (covered electric wire)
15 covered electric wire
17 core wire
21 insulation cover
25 core wire exposed portion
27 core wire welding portion
29 gap
31 water stop material
33 heat shrinkable tube

1. A water stopping structure comprising:
a covered electric wire configured to have a plurality of core wires and an insulation cover covering the core wires; and
a core wire welding portion configured to be provided in a part of the covered electric wire where the insulation cover is removed and the core wires are exposed to the outside,
wherein in the core wire welding portion, the core wires are welded to each other;
wherein a gap between the core wires, which has a size capable of being filled up with a low viscosity water stop material by capillarity action, is formed in the core wire welding portion; and
wherein the gap is filled up with the water stop material.

2. The water stopping structure according to claim 1, further comprising:
a heat shrinkable tube configured to cover the core wire welding portion and configured to be extended to the insulation cover adjacent at both ends of the core wire welding portion,
wherein the heat shrinkable tube is brought into close contact with the core wire welding portion and an outer peripheral surface of the insulation cover adjacent at both ends of the core wire welding portion.

3. A water stopping method comprising:
forming a core wire exposed portion by removing an insulation cover of a covered electric wire in which a plurality of core wires is covered with the insulation cover;
forming a core wire welding portion having a gap between the core wires, by shrinking to a size of the gap capable of being filled up with a low viscosity water stop material by capillarity action by performing a welding processing for the core wires of the core wire exposed portion; and
filling up the gap with the low viscosity water stop material by the capillarity action.

4. The water stopping method according to claim 3, further comprising:
covering the core wire welding portion and the insulation cover adjacent at both ends of the core wire welding portion with a heat shrinkable tube; and
applying heat to the heat shrinkable tube so that the heat shrinkable is brought into close contact with the core wire welding portion and an outer peripheral surface of the insulation cover adjacent at both ends of the core wire welding portion.

5. The water stopping method according to claim 4, wherein the heat shrinkable tube is shrunk when the water stop material is in an uncured state so that the uncured water stop material is press-fitted into the gap due to shrinking pressure of the heat shrinkable tube.
